(19) United States
(12) Patent Application Publication
(10) Pub. No.: US 2017/0163309 A1
(43) Pub. Date: Jun. 8, 2017

(54) WIRELESS TERMINAL, WIRELESS STATION, WIRELESS COMMUNICATION SYSTEM, AND WIRELESS COMMUNICATION METHOD

(71) Applicant: FUJITSU LIMITED, Kawasaki-shi (JP)

(72) Inventors: Yoshiaki Ohta, Yokohama (JP); YOSHIHIRO KAWASAKI, Kawasaki (JP)

(73) Assignee: FUJITSU LIMITED, Kawasaki-shi (JP)

(21) Appl. No.: 15/433,719

(22) Filed: Feb. 15, 2017

Related U.S. Application Data
(63) Continuation of application No. PCT/JP2014/004344, filed on Aug. 22, 2014.

(51) Int. Cl. H04J 3/08

(52) U.S. Cl. CPC H04B 1/707

(57) ABSTRACT

A wireless terminal including: a memory, and a processor coupled to the memory and the processor configured to: cause the wireless terminal to make a transition to an idle mode when, after it is determined that a first wireless link established with a wireless station by the wireless terminal is not maintained, a cumulative processing time from initiation of processing for selecting one of wireless stations other than the wireless station and for establishing a second wireless link or the number of times of failure in the processing reaches a first threshold value, wherein in accordance with a quality of the first wireless link or the second wireless link, the processor is configured to initiate terminal-to-terminal communication or prompt to initiate the terminal-to-terminal communication without causing the wireless terminal to make a transition to the idle mode.

### CROSS-REFERENCE TO RELATED APPLICATIONS

This application is a continuation application of International Application PCT/JP2014/004344 filed on Aug. 22, 2014 and designated the U.S., the entire contents of which are incorporated herein by reference.

### FIELD

The present invention relates to a wireless terminal, a wireless station, a wireless communication system, and a wireless communication method.

### BACKGROUND

In recent years, in order to achieve wireless communication having a higher speed, a larger capacity, and so forth in a wireless communication system such as a mobile phone system (cellular system), a next-generation wireless communication technology has been in discussion. In the 3GPP (3rd Generation Partnership Project) being a standardization organization, a communication standard called the LTE (Long Term Evolution) and a communication standard based on a wireless communication technology of the LTE and called the LTE-A (LTE-Advanced) are proposed, for example.

The latest communication standard completed in the 3GPP is the Release 10 compatible with the LTE-A, and this is obtained by greatly enhancing the functions of the Releases 8 and 9 compatible with LTE. At present, a discussion of a main part of the Release 11 obtained by further extending the Release 10 finishes, and the details thereof are currently developed to the completion thereof. Furthermore, a discussion of the Release 12 is started. Hereafter, it is assumed that unless otherwise noted, in addition to the LTE and the LTE-A, the “LTE” includes other wireless communication systems obtained by extending these.

The LTE (LTE-A) includes various technologies, and, as one of these, there is the D2D (Device to Device). The D2D is so-called wireless terminal-to-terminal communication in the 3GPP. In the LTE, usually even two wireless terminals located a short distance away from each other perform communication via a base station, whereas according to the D2D, two wireless terminals are able to directly perform communication with each other not via a base station.

FIG. 1 illustrates a conceptual diagram of the D2D (the wireless terminal-to-terminal communication). In FIG. 1, a base station 10 and two wireless terminals 20a and 20b are illustrated (note that in the present application, the wireless terminals are collectively referred to as wireless terminals 20). FIG. 1 illustrates a state in which the two wireless terminals 20a and 20b perform the D2D.

According to the D2D, by using predetermined wireless resources, wireless terminals become able to autonomously perform wireless communication with each other to some extent. Therefore, in view of effective usage of wireless resources, suppression of a processing load on a base station, and so forth, the D2D attracts attention. In addition, it is studied to utilize the D2D in order to support Public Safety (public safety). Specifically, even when, for example, a base station stops an operation at a time of a disaster, it is expected that the D2D enables wireless communication to be continued. In this way, since having various availabilities, the D2D attracts attention, as a promising technology, from differing points of view. While a discussion related to the D2D has only just begun in the 3GPP, an active discussion is supposed to be going to continue in the future.

By the way, usually communication is switched between traditional communication via a base station and the wireless terminal-to-terminal communication. Therefore, in order to initiate the wireless terminal-to-terminal communication after communication is switched from the traditional communication via a base station, some kind of trigger (an opportunity) is needed. As such a trigger, an explicit operation performed by a user on a wireless terminal is assumed, for example. In addition, it is further assumed that reception of an instruction signal from a base station is treated as a trigger.

### CITATION LIST

### Patent Literature

PTL 1: Japanese Laid-open Patent Publication No. 2006-319555

PTL 2: Japanese Laid-open Patent Publication No. 2002-199126

PTL 3: Japanese Laid-open Patent Publication No. 11-55740

PTL 4: Japanese Laid-open Patent Publication No. 2001-357480

### SUMMARY

According to an aspect of the embodiment, a wireless terminal includes a memory, and a processor coupled to the memory and the processor configured to: cause the wireless terminal to make a transition to an idle mode when, after it is determined that a first wireless link established with a wireless station by the wireless terminal is not maintained, a cumulative processing time from initiation of processing for selecting one of wireless stations other than the wireless station and for establishing a second wireless link or the number of times of failure in the processing reaches a first threshold value, wherein in accordance with a quality of the first wireless link or the second wireless link, the processor is configured to initiate terminal-to-terminal communication or prompt to initiate the terminal-to-terminal communication without causing the wireless terminal to make a transition to the idle mode.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a conceptual diagram of wireless terminal-to-terminal communication.

FIG. 2 is a diagram illustrating an example of a sequence of a wireless communication system according to a reference technology.

FIG. 3 is a diagram illustrating an example of a sequence of a wireless communication system according to a first embodiment.

FIG. 4 is a diagram illustrating an example of a sequence of a wireless communication system according to a second embodiment.

FIG. 5 is a diagram illustrating an example of a sequence of a wireless communication system according to a third embodiment.

FIG. 6 is a diagram illustrating an example of a sequence of a wireless communication system according to a fourth embodiment.

FIG. 7 is a diagram illustrating an example of a network configuration of the wireless communication system of each of the embodiments.

FIG. 8 is an example of a functional configuration diagram of a base station in the wireless communication system of each of the embodiments.

FIG. 9 is an example of a functional configuration diagram of a mobile wireless phone terminal in the wireless communication system of each of the embodiments.

FIG. 10 is an example of a hardware configuration diagram of a base station in the wireless communication system of each of the embodiments.

FIG. 11 is an example of a hardware configuration diagram of a mobile wireless phone terminal in the wireless communication system of each of the embodiments.

### DESCRIPTION OF EMBODIMENTS

However, as describe later, if being based on such a simple trigger as described above, there is concern that the wireless terminal-to-terminal communication cannot be initiated at an adequate timing in some cases. In addition, not initiating the wireless terminal-to-terminal communication at an adequate timing can cause a problem that the effectiveness of the wireless terminal-to-terminal communication is not fully exerted and as a result, various types of waste are made. This problem is found out by a detailed technological study based on inventors.

The disclosed technology is developed in view of the above, and an object thereof is to provide a wireless terminal, a wireless station, a wireless communication system, and a wireless communication method, which each enable wireless terminal-to-terminal communication to be initiated at an adequate timing.

Hereinafter, by using drawings, embodiments of a wireless terminal, a wireless station, a wireless communication system, and a wireless communication method, will be described. Note that while, for the sake of convenience, the embodiments will be described as separate embodiments, it goes without saying that the individual embodiments are combined, thereby obtaining advantageous effects of the combination, and furthermore it is possible to enhance an availability.

[Where Problem is]

As described above, in the related art, there is a problem that the wireless terminal-to-terminal communication cannot be initiated at an adequate timing. First, before describing the individual embodiments, this problem will be described. Note that this problem is newly found out as a result of a detailed study of the related art by the inventors and has not been known in the past.

In general, in a wireless communication system (may be restated as a mobile phone system or a cellular system) such as the LTE system of the related art, the two wireless terminals 20 performs communication via the base station 10 (hereafter, such a communication configuration is called a “via-base-station communication” for the sake of convenience). In contrast, in the terminal-to-terminal communication such as the D2D in the LTE system, the two wireless terminals 20 directly perform wireless communication without involving the base station 10. Note that while, in what follows, without using the term, “D2D”, in the LTE system, a description will be advanced by using the more general term, “terminal-to-terminal communication”, the “terminal-to-terminal communication” may be arbitrarily restated as the “D2D”.

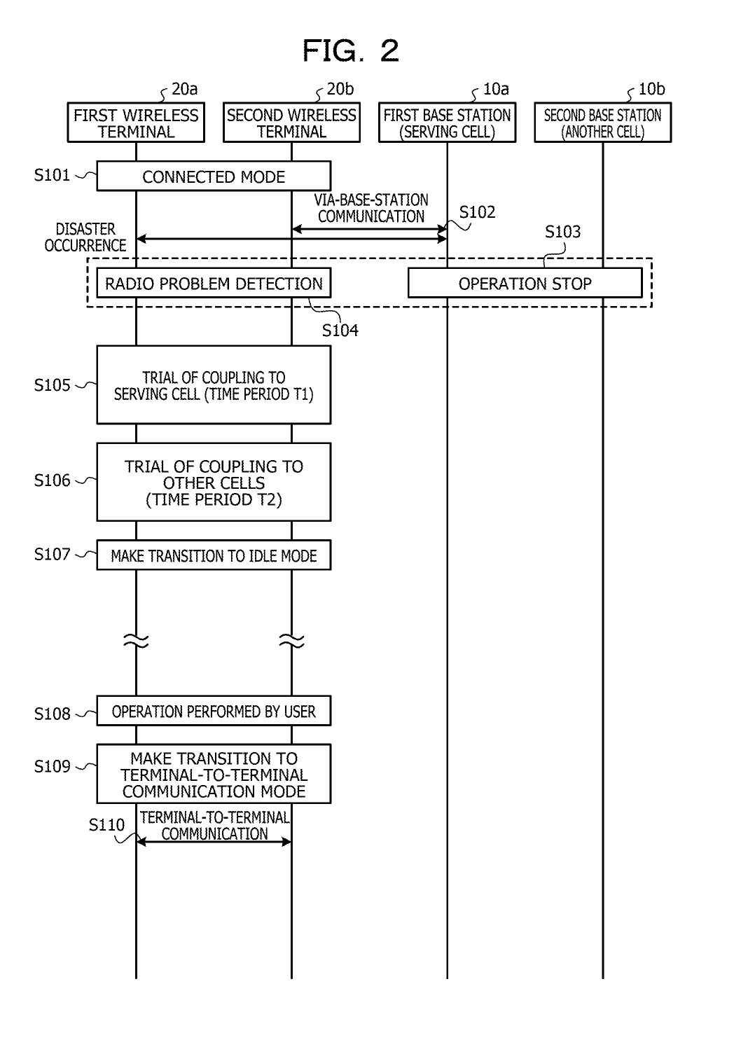

By the way, as described above, introducing the terminal-to-terminal communication into support of the Public Safety (public safety) is being considered. From this, even when the base station 10 stops an operation at a time of, for example, a disaster, it is expected that the terminal-to-terminal communication (D2D) enables wireless communication to be continued. In a case where the base station 10 stops an operation by itself in a normal operation state, when some conditions are satisfied, the wireless terminals 20 that have been coupled to the stopped base station 10 are able to continue the wireless communication by trying coupling to a neighboring base station (a first base station 10b in FIG. 2, described later). However, at a time of a disaster such as a major earthquake, a case where the base stations 10 in an area simultaneously stop operations is supposed. Therefore, it can become impossible for the wireless terminals 20 to be coupled to neighboring base stations 10b. In such a state in which the base stations 10 are absent, it is conceivable that the terminal-to-terminal communication may function as an effective breakthrough.

Note that, in the “operation stop” of the base station 10, handled in the present application, a case where all or most of the base stations 10 become dysfunctional is assumed rather than a case where some functions of the base stations 10 are stopped by failures or the like. Specifically, there is a case where the base stations 10 are wrecked by a major earthquake, for example. In the present application, the “operation stop” may be restated as “failed”, “crashed”, or the like.

Here, in line with the current specification of the 3GPP, there will be outlined behaviors of the wireless terminals 20 when the wireless terminals 20 that currently perform communication encounter a disaster such as a major earthquake and the neighboring base stations 10b simultaneously stop an operation in addition to the base station 10 to which the wireless terminals 20 are coupled.

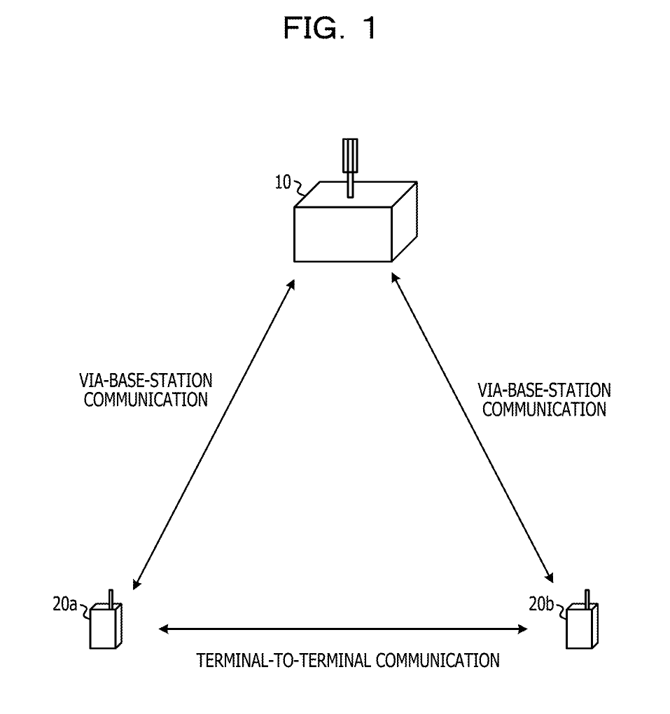

FIG. 1 illustrates an example of a processing sequence of a wireless communication system at a time of a disaster, the processing sequence being consistent with the current specification of the 3GPP. Note that, in the present application, a technology illustrated in FIG. 1 is called a reference technology.

In FIG. 1, there is described processing performed by the first wireless terminal 20a and the second wireless terminal 20b, which are the two wireless terminals 20, and a first base station 10a and a second base station (the first base station 10b in FIG. 2, described later), which are the two base stations 10. Note that, in what follows, unless otherwise noted, the first wireless terminal 20a and the second wireless terminal 20b are simply collectively referred to as the wireless terminals 20 and the first base station 10a and the second base station 10b are simply collectively referred to as the base stations 10.

First, as illustrated in S101 in FIG. 2, as a premise, it is assumed that each of the wireless terminals 20 is in a connected mode. The connected mode is specified as RRC_CONNECTED in the specification of the 3GPP and indicates a state of being coupled to the corresponding one of the base stations 10. Here, “being coupled” means a state in which a synchronized wireless link is established between the corresponding one of the wireless terminals 20 and the corresponding one of the base stations 10, the corresponding one of the base stations 10 manages wireless resources of the corresponding one of the wireless terminals 20, and the corresponding one of the wireless terminals 20 is able to perform wireless communication with the corresponding one of the base stations 10 at any time.

Now, it is assumed that the first wireless terminal 20a and the second wireless terminal 20b are coupled to the first base station 10a. At this time, the first base station 10a is a serving cell 10a (serving station 10a) for each of the first wireless terminal 20a and the second wireless terminal 20b and corresponds to the coupling base station 10a. On the other hand, the second base station 10b is another cell 10b (another station 10b) for each of the first wireless terminal 20a and the second wireless terminal 20b and corresponds to one of the neighboring base stations 10b.

Here, the neighboring base stations 10b each indicate a base station that is other than the coupling base station 10a and that is included in the base stations 10 located near the corresponding one of the wireless terminals 20 to the extent that the wireless terminal 20 is able to measure at least a wireless signal. While each of the neighboring base stations 10b is called an adjacent base station in some cases, note that the serving cell 10a corresponding to the coupling base station 10a and the other cells 10b corresponding to the neighboring base stations 10b do not have to be physically adjacent to each other. In addition, while, in FIG. 2 and drawings subsequent thereto, due to limitations of space, only one of the other cells 10b is illustrated, also note that usually the other cells 10b exist.

In S102 in FIG. 2, as an example, the first wireless terminal 20a and the second wireless terminal 20b perform wireless communication with each other via the first base station 10a. The wireless communication in S102 is not so-called terminal-to-terminal communication but corresponds to a traditional wireless communication in a wireless communication system including the base stations 10.

It is assumed that, in such a case, the wireless terminals 20 encounter a disaster such as a major earthquake. In addition, as illustrated in S103 in FIG. 2, it is assumed that every one of the first base station 10a being the serving cell 10a and the second base station 10b being the other cell 10b stops an operation. From this, the base stations 10 become not able to transmit wireless signals (downlink signals).

At this time, as illustrated in S104 in FIG. 2, the wireless terminals 20 each detect a radio problem (radio problem) with the first base station 10a being the serving cell 10a. The radio problem corresponds to a failure of wireless communication and includes, for example, a synchronization loss of a wireless link and so forth. While the radio problem may be detected by using one of various methods, that may be performed based on success or failure of detection of, for example, synchronization signals periodically transmitted by the respective base stations 10.

At this time, as illustrated in S105 in FIG. 2, the wireless terminals 20 each try recoupling to the first base station 10a being the serving cell 10a and each ensure recovery from the radio problem. The reason is that the radio problem may be associated with a simple synchronization loss or temporary quality degradation of a wireless link. At this point of time, each of the wireless terminals 20 cannot clearly determine whether a cause of the radio problem is due to, for example, a simple synchronization loss, being out of range from a coverage of the serving cell 10a, or other reasons (including simultaneous operation stop of neighboring cells). Therefore, first the wireless terminals 20 each try recoupling to the serving cell 10a and each ensure recovery from the radio problem.

However, since the first base station 10a being the serving cell 10a stops an operation in S103, a trial of recoupling, performed by each of the wireless terminals 20, fails in S105. In a case of failing in recoupling, the wireless terminals 20 each retry recoupling, and in a case of further failing, the wireless terminals 20 each repeat recoupling. In addition, in a case of not succeeding in recoupling even after the elapse of a predetermined time period T1 (a parameter set in advance), the wireless terminals 20 each recognize the occurrence of a failure of a radio link (radio link failure) and each make a transition to a subsequent stage. Note that, in each of the wireless terminals 20 at this time, the connected mode is maintained.

Next, as illustrated in S106 in FIG. 2, the wireless terminals 20 each try coupling to the other cells 10b (the neighboring base stations 10b) including the second base station 10b. This is because a reason for radio link failures between the wireless terminals 20 and the serving cell 10a (the first base station 10a) may be that the wireless terminals 20 are out of range from the coverage of the serving cell 10a. At this point of time, each of the wireless terminals 20 cannot clearly determine whether a cause of the radio link failure is due to the coverage or other reasons (including simultaneous operation stop of neighboring cells). Therefore, the wireless terminals 20 each select one from among the one or more other cells 10b, each try coupling thereto, and each ensure establishment of a wireless link with one of the other cells 10b. Such selection processing of the base stations 10 is called selecting cell (cell selection). More specifically, the wireless terminals 20 each try receiving a wireless signal from each of the one or more other cells 10b, each select one of the other cells 10b (each select one of the other cells 10b, which has, for example, a maximum reception power), based on a receivable wireless signal, and each try coupling to the selected other cell 10b.

However, since it is assumed that each of the other cells 10b (neighboring base stations 10b) stops an operation, the wireless terminals 20 each fail in trying coupling to the other cells 10b, for every one of the other cells 10b. In a case of failing in trying coupling to the other cells 10b, the wireless terminals 20 each retry coupling, and in a case of further failing, the wireless terminals 20 each repeat retrying. In addition, in a case of succeeding in coupling to none of the other cells 10b even after the elapse of a predetermined time period T2 (a parameter set in advance), the wireless terminals 20 each make a transition from the connected mode to an idle mode, as illustrated in S107 in FIG. 2. The idle mode is specified as RRC_IDLE in the specification of the 3GPP and corresponds to a so-called standby state.

While the idle mode is maintained after that, when uplink data is generated in the corresponding one of the wireless terminals 20, the wireless terminal 20 tries coupling to one of the cells (base stations 10) so as to return to the connected mode. However, since every one of the other cells 10b stops an operation in addition to the serving cell 10a, it cannot return to the connected mode. Therefore, the corresponding one of the wireless terminals 20 may waste time and power consumption while wireless communication via the base stations 10 cannot be performed.

The above is a procedure consistent with the current specification of the 3GPP when the wireless terminals 20 encounter a disaster such as a major earthquake.

Here, it is conceivable that when a user recognizes that communication via the base stations 10 is impossible or difficult, the user explicitly operates, as illustrated in S108 in FIG. 2, the corresponding one of the wireless terminals 20, thereby causing the corresponding one of the wireless terminals 20 to make a transition from the idle mode to the terminal-to-terminal communication mode as illustrated in S109. From this, as illustrated in S110, the corresponding one of the wireless terminals 20 is able to initiate the terminal-to-terminal communication.

However, it is conceivable that if initiation of the terminal-to-terminal communication is entrusted to the operation of the user as the reference technology illustrated in FIG. 2, a possibility that the terminal-to-terminal communication cannot be initiated at an adequate timing is increased. Even if the user is able to recognize, for example, at least a failure of wireless communication, it is increasingly difficult for the user to understand that the cause thereof is due to simultaneous operation stop of the base stations 10. As the cause of a failure of wireless communication, specifically at a time of a disaster, the occurrence of a failure due to congestion of communication is easily recalled in addition to a simple synchronization loss, temporary quality degradation of a wireless link, being out of range from a coverage, and so forth. Therefore, it may be readily understood that the user thinks that the failure of wireless communication will be resolved after a short time and accordingly the user takes no particular action. However, it takes a large amount of time for the base stations 10 to recover from operation stop or it takes a large amount of time to install a mobile base station 10 (nomadic base station 10). Therefore, the failure of communication turns out not to be resolved, for a long time. From this, the wireless terminals 20 each miss an opportunity of wireless communication for a long time, and power consumption turns out to be wasted, in such a manner as a procedure described above.

Summarizing the above, if a disaster such as a major earthquake causes the other cells 10b to simultaneously stop operations in addition to the serving cells 10a, in a case of simply following the specification of the 3GPP of the related art, it becomes not able to initiate the terminal-to-terminal communication at an adequate timing. From this, there occurs a problem that, at a time of a disaster, the continuity of wireless communication is deteriorated and power consumption of the wireless terminals 20 is wasted. Note that this problem is newly found out as a result of a detailed study of the related art by the inventors and has not been known in the past. In addition, while the above description is performed in line with the LTE system, note that this problem is not limited to the LTE system and the same wireless communication system as this may have this problem. In what follows, individual embodiments of the present application, used for solving this problem, will be described in order.

### First Embodiment

A first embodiment is an embodiment according to a wireless communication system including the wireless terminals 20, wherein the wireless terminals 20 each include a control unit configured to cause the corresponding one of the wireless terminals 20 to make a transition to an idle mode (or a standby state) when after it is determined that a first wireless link established with a wireless station by the corresponding one of the wireless terminals 20 is not maintained, a cumulative processing time from initiation of processing for selecting one of wireless stations other than the wireless station and for establishing a second wireless link or the number of times of failure in the processing reaches a first threshold value, and wherein in accordance with a quality of the first wireless link or the second wireless link, the control unit initiates terminal-to-terminal communication or prompts to initiate the terminal-to-terminal communication, without causing the corresponding one of the wireless terminals 20 to make a transition to the idle mode.

Here, while one of the base stations 10 is conceivable as the above-mentioned wireless station, the above-mentioned wireless station may be another wireless communication device including a third wireless terminal 20 or the like. As an example, there is conceivable a case where, at a time when a disaster or the like causes the base stations 10 to failure, the wireless terminals 20 act for functions of the base stations 10. In each of the present embodiment and embodiments described later, a case where the wireless station is one of the base stations 10 will be described, embodiments are not limited to this.

In what follows, a case where the present invention is applied in the LTE system will be described. However, note that the present invention is not limited to the LTE system and may be applied to the same wireless communication system having the problem explained in the above description.

In addition, in the first embodiment, there are many processing operations that are in common with or similar to the reference technology described above (FIG. 2). Therefore, in what follows, the first embodiment will be described in detail with a focus on points different from the reference technology. Note that, in the first embodiment, descriptions that overlap with the reference technology will be arbitrarily omitted.

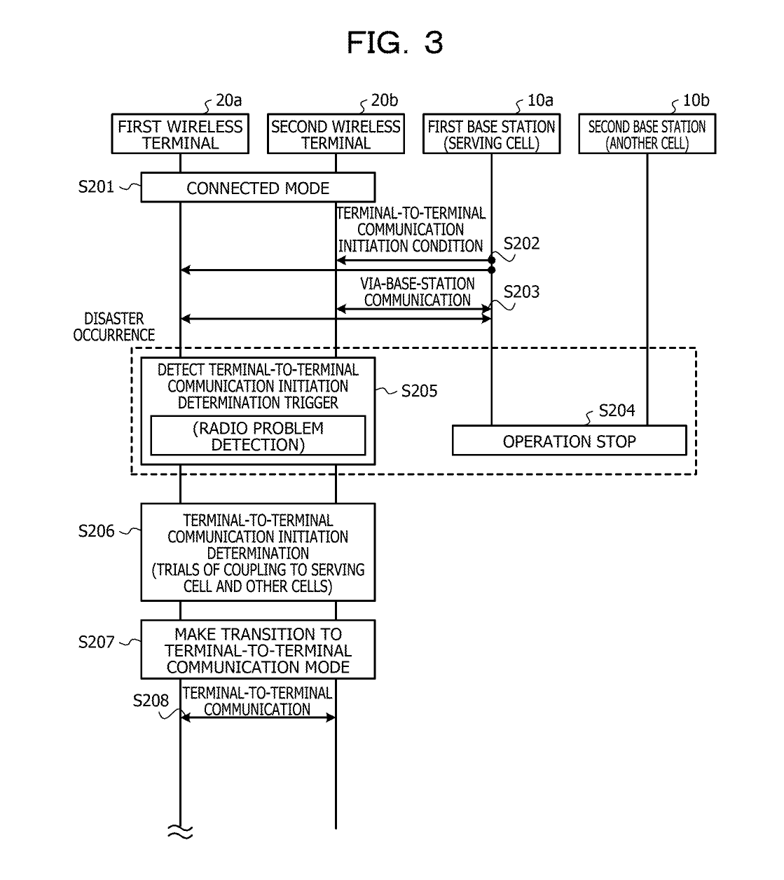

FIG. 3 is a diagram illustrating an example of a processing sequence according to the first embodiment. Since the assumption of the first embodiment illustrated in FIG. 3 is the same as that of the reference technology illustrated in FIG. 2, the description thereof will be omitted.

First, as illustrated in S201 in FIG. 3, each of the wireless terminals 20 is in the connected mode. Since S201 is the same as S101 in FIG. 2, here the description thereof will be omitted.

In S202 in FIG. 3, the first base station 10a (serving cell 10a) transmits, to the first wireless terminal 20a and the second wireless terminal 20b, information related to an initiation condition of the terminal-to-terminal communication. In what follows, for the sake of convenience, the information is called a terminal-to-terminal communication initiation condition. Note that here the “information” may be restated as a “signal”, a “message”, or the like.

It is assumed that the terminal-to-terminal communication initiation condition in the present application includes at least a condition related to the above-mentioned time period T2. In addition, it may be assumed that the terminal-to-terminal communication initiation condition further includes the above-mentioned T1. Here, T1 corresponds to a time period of trying coupling to the serving cell 10a at a time of a failure of a wireless link, and T2 corresponds to a time period of trying coupling to the other cells 10b.

As the terminal-to-terminal communication initiation condition, the maximum number of times of failure (defined as M2 for the sake of convenience) in coupling to the other cells 10b in the time period T2 may be adopted, for example. In addition, the terminal-to-terminal communication initiation condition may be set to a time period (defined as T′2 for the sake of convenience) during which coupling to the neighboring base stations 10b is tried within T2. T′2 corresponds to an upper limit value of the cumulative processing time during which coupling to the neighboring base stations 10b is tried within T2. Therefore, 0≦T′2≦T2 is satisfied. If M2 or T′2 being the terminal-to-terminal communication initiation condition is increased, the accuracy of determination of initiation of the terminal-to-terminal communication is improved, whereas the initiation of the terminal-to-terminal communication is delayed. On the other hand, if these are decreased, the initiation of the terminal-to-terminal communication is accelerated, whereas the accuracy of determination of the initiation of the terminal-to-terminal communication may be reduced. Therefore, it is desirable that these parameters are determined in view of a balance between the accuracy of determination of the initiation of the terminal-to-terminal communication and an initiation timing.

As the terminal-to-terminal communication initiation condition, M1 or T′1 may be set for T1 being a trial time period of coupling to the serving cell 10a, in such a way as to set M2 or T′2 as the terminal-to-terminal communication initiation condition for T2 being a trial time period of coupling to the other cells 10b. In addition, the terminal-to-terminal communication initiation condition does not have to be specifically set for a trial of coupling to the serving cell 10a and the trial of coupling to the serving cell 10a may be unconditionally skipped (skipped). The reason is that it is contemplated that, in many cases, the trial of coupling to the serving cell 10a does not have to be performed.

The terminal-to-terminal communication initiation condition in S202 is transmitted by the corresponding one of the base stations 10 to the wireless terminals 20 by suing an RRC signal, for example. FIG. 2 illustrates an example in which the wireless terminals 20 each receive the terminal-to-terminal communication initiation condition after being put into the connected mode. However, it may be assumed that the terminal-to-terminal communication initiation condition is transmitted in processing used by the wireless terminals 20 to make transitions to the connected mode.

In S203 in FIG. 3, as an example, the first wireless terminal 20a and the second wireless terminal 20b perform wireless communication with each other via the first base station 10a. The wireless communication in S203 is not so-called terminal-to-terminal communication but corresponds to traditional wireless communication in the wireless communication system including the base stations 10.

It is assumed that, in such a case, the wireless terminals 20 encounter a disaster such as a major earthquake. In addition, it is assumed that, as illustrated in S204 in FIG. 3, every one of the first base station 10a being the serving cell 10a and the second base station 10b being one of the other cells 10b stops an operation. From this, the base stations 10 become not able to transmit wireless signals (downlink signals).

It is assumed that, at this time, the wireless terminals 20 in S205 in FIG. 3 each detect an event to be a trigger for determining initiation of the terminal-to-terminal communication. In what follows, for the sake of convenience, this event is called a terminal-to-terminal communication initiation determination trigger. In the present embodiment, when the terminal-to-terminal communication initiation determination trigger is detected, whether or not the terminal-to-terminal communication has to be initiated is swiftly determined, thereby reaching a solution to a problem associated with the above-mentioned reference technology.

As the terminal-to-terminal communication initiation determination trigger, there may be adopted an event which implies that it is impossible or difficult to maintain at least a wireless link with the serving cell 10a and which implies a possibility of simultaneous operation stop of nearby base stations 10 (including the serving cell 10a and the other cells 10b). The terminal-to-terminal communication initiation determination trigger may be a single event or may be a combination of events. A specific example of the terminal-to-terminal communication initiation trigger will be allowed to be explained in other embodiments described later.

Note that determination of initiation of the terminal-to-terminal communication in the present embodiment is performed based on a trial of coupling to the serving cell 10a or the other cells 10b, as described later. From that standpoint, it may be thought that the terminal-to-terminal communication initiation determination trigger is an event corresponding to the “radio problem” being a trigger for a trial of coupling to a cell in the reference technology. Therefore, the detection of the terminal-to-terminal communication initiation determination trigger may be realized by detection of events including the radio problem. In this regard, however, when the radio problem does not have to be detected, for example, when the serving cell 10a is highly likely to stop an operation, the terminal-to-terminal communication initiation determination trigger may be caused not to include the radio problem. In any case, regarding details of the terminal-to-terminal communication initiation determination trigger, other embodiments described later may be referenced.

Upon detecting the terminal-to-terminal communication initiation determination trigger in S205 in FIG. 3, the wireless terminals 20 each initiate terminal-to-terminal communication initiation determination in S206. As described above, the determination of the initiation of the terminal-to-terminal communication in the present embodiment is performed based on a trial of coupling to the serving cell 10a or the other cells 10b. In addition, based on the terminal-to-terminal communication initiation condition received in S202, the wireless terminals 20 each perform the terminal-to-terminal communication initiation determination.

A specific example of S206 will be described. Here, a case where, as the terminal-to-terminal communication initiation condition in S202, M2 (described above) is adopted for a trial of coupling to the other cells 10b will be described as an example. In addition, in this example, it is assumed that a trial of coupling to the serving cell 10a will be unconditionally skipped.

In this case, in S206, the wireless terminals 20 each initiate a trial of coupling to the other cells 10b without performing a trial of coupling to the serving cell 10a. In other words, the wireless terminals 20 each skip a trial of recoupling to the serving cell 10a.

Continuously in S206, it is assumed that the wireless terminals 20 each only perform a trial of coupling to the other cells 10b M2 times at a maximum. From this, even if coupling to the other cells 10b does not succeed and the time period T2 does not elapse, a trial of coupling to the other cells 10b is completed at a time when the number of times of failure in a trial of coupling to the other cells 10b reaches M2 times. In other words, in accordance with wireless link qualities with the other cells, the terminals each terminate a trial of coupling to the other cells 10b before the time period T2 elapses.

Here, when, in S206, a trial of coupling to the other cells 10b succeeds before the number of times of failure therein reaches M2 times, it is determined that the terminal-to-terminal communication is not to be initiated (in other words, it is determined that the terminal-to-terminal communication is undesired). The reason is that since it is possible to perform wireless communication via the other cells 10b, the terminal-to-terminal communication does not have to be performed. In this case, in each of the wireless terminals 20, the connected mode turns out to be maintained.

In contrast, when, in S206, the number of times of failure in a trial of coupling to the other cells 10b reaches M2 times, it is determined that the terminal-to-terminal communication is to be initiated (in other words, it is determined that the terminal-to-terminal communication is desired). At this time, as illustrated in FIG. 3, the wireless terminals 20 each make, in S207, a transition from the connected mode to the terminal-to-terminal communication mode and each initiate, in S208, the terminal-to-terminal communication. Note that as operation modes of the terminal-to-terminal communication, a mode for performing transmission and reception (of, for example, a distress signal and so forth), a relay mode for performing relay-transmission, a standby mode, and so forth are conceivable. By arbitrarily switching these in accordance with states, it becomes possible to perform effective terminal-to-terminal communication.

Here, the processing operations in S206 to S208 in FIG. 3 according to the present embodiment are compared with processing operations in FIG. 2 according to the above-mentioned reference technology.

First, in the reference technology, when the wireless terminals 20 cannot be coupled to the other cells 10b (S106), the wireless terminals 20 each make a transition to the idle mode and are each put into the standby state (S107). Therefore, a delay is generated before the terminal-to-terminal communication is initiated by an operation of a user after that. In contrast, in the present embodiment, when the wireless terminals 20 cannot be coupled to the other cells 10b (S206), the wireless terminals 20 each make a transition to the terminal-to-terminal communication mode and each initiate the terminal-to-terminal communication (S207 to S208). Therefore, such a delay as in that reference technology is not generated. Accordingly, in a state in which simultaneous operation stop of the base stations 10 is forecast, it is possible for each of the wireless terminals 20 to swiftly initiate the terminal-to-terminal communication at an adequate timing. As a result, it becomes possible for each of the wireless terminals 20 to continuously wireless communication, and furthermore, a trial of coupling to the base stations 10 after the standby state is avoided. Therefore, power consumption of the wireless terminals 20 is expected to be suppressed.

Next, in S206 in FIG. 3 according to the present embodiment, it is assumed that each of the wireless terminals 20 skips a trial of recoupling to the serving cell 10a, as described above. The reason is that since, based on the detection of the terminal-to-terminal communication initiation determination trigger, it may be thought that at least the serving cell 10a is likely to stop an operation, it may be thought that recoupling to the serving cell 10a does not have to be performed or is hardly desired. By doing so, it is possible to further accelerate a timing at which the terminal-to-terminal communication is initiated, and it is possible to further suppress power consumption in the wireless terminals 20.

Furthermore, in S206 in FIG. 3 according to the present embodiment, it is assumed that the wireless terminals 20 each only perform a trial of coupling to the other cells 10b M2 times at a maximum. In other words, in S206, even if a trial of coupling to the other cells 10b does not succeed and the time period T2 does not elapse, a trial of coupling to the other cells 10b is only performed up to M2 times. The reason is that since, based on the detection of the terminal-to-terminal communication initiation determination trigger, it may be thought that the other cells 10b are relatively highly likely to stop operations, it may be thought that even if a trial of coupling to these is given up earlier than usual, problems are reduced. In addition, by doing so, it is possible to further accelerate a timing at which the terminal-to-terminal communication is initiated, and it is possible to further suppress power consumption in the wireless terminals 20.

Here, note that the processing operations in S206 to S208 explained in the above description are based on the premise of the detection of the terminal-to-terminal communication initiation determination trigger in S205. In other words, when the terminal-to-terminal communication initiation determination trigger is not detected (a case where just the radio problem is only detected, for example), the wireless terminals 20 each perform processing (corresponding to S105 to S107 in FIG. 2) consistent with the specification of the 3GPP of the related art. Therefore, when wireless links between, for example, the wireless terminals 20 and the serving cell 10a are merely temporarily deteriorated, processing for recoupling to the serving cell 10a is performed in line with the specification of the 3GPP of the related art as a matter of course. It is additionally remarked that, in this way, in the present embodiment, except when simultaneous operation stop of the base stations 10 is forecast, a desired processing procedure is not skipped and undesired terminal-to-terminal communication is not initiated.

Note that after the terminal-to-terminal communication is initiated, when a synchronization signal from, for example, the corresponding one of the base stations 10 is detected, the wireless terminals 20 each terminate the terminal-to-terminal communication. Here, it does not matter whether one of the base stations 10, which transmits the synchronization signal, is the serving cell 10a, one of the other cells 10b (a cell, coupling to which is tried in S206), or a cell (for example, a Nomadic cell) other than this. The reason is that in any case, when the synchronization signal from one of the base stations 10 is detected, the terminal-to-terminal communication does not have to be performed. After that, the wireless terminals 20 turn out to perform wireless communication via the base station 10.

According to the first embodiment described above, while initially performing wireless communication via the serving cell 10a (coupling base station 10a), the wireless terminals 20 each make a transition to the terminal-to-terminal communication once in association with simultaneous operation stop of the base stations 10 and each return to the wireless communication via the corresponding one of the base stations 10 in association with recovery or the like of the base stations 10. In addition, the wireless terminals 20 each give up coupling to the base stations 10 earlier than usual and are each able to swiftly initiate the terminal-to-terminal communication at an adequate timing. From this, compared with the technology of the related art, it is possible to considerably suppress an interruption of wireless communication, and it becomes possible to suppress useless power consumption in the wireless terminals 20. Therefore, according to the first embodiment, it becomes possible to solve the problem contained by the reference technology described above.

### Second Embodiment

A second embodiment specifically realizes the first embodiment and, in particular, adopts an ETWS signal and signal stop as the terminal-to-terminal communication initiation determination trigger.

Since the second embodiment more specifically realizes the first embodiment, the second embodiment will be described in detail with a focus on points different from the first embodiment, in what follows. Note that, in the second embodiment, descriptions that overlap with the first embodiment will be arbitrarily omitted.

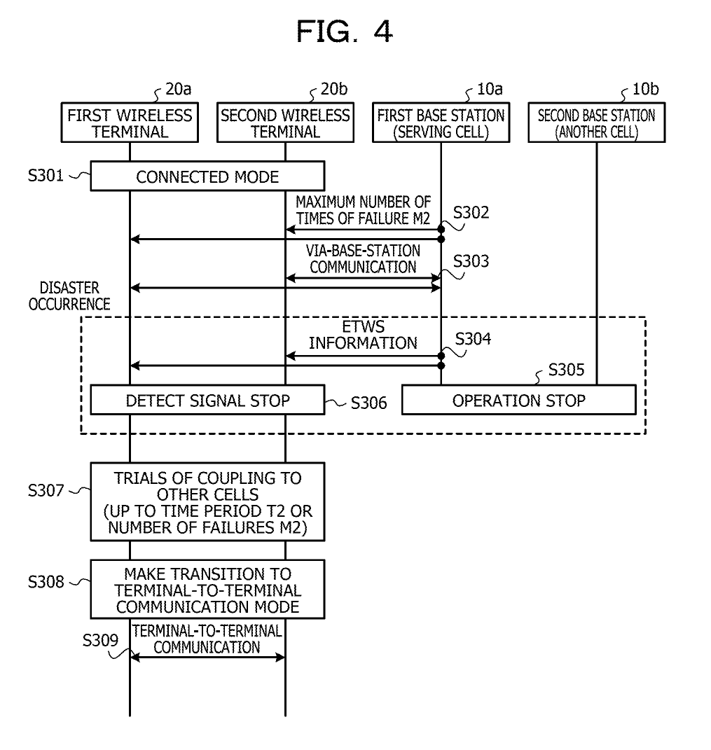

FIG. 4 is a diagram illustrating an example of a processing sequence according to the second embodiment. Since the assumption of the second embodiment illustrated in FIG. 4 is the same as that of the reference technology or the first embodiment, described above, the description thereof will be omitted.

Since S301 to S303 in FIG. 4 are the same as 201 to S203, respectively, in FIG. 3, the detailed descriptions thereof will be omitted. Note that, in the present embodiment, it is assumed that, in the same way as in the exemplification in the first embodiment, M2 (described above) is adopted, as a wireless-terminal-20-wireless-terminal-20 initiation condition, for a trail of coupling to the other cells 10b and a trial of coupling to the serving cell 10a is unconditionally skipped. In this regard, however, note that these are just examples and the terminal-to-terminal communication is not limited to these.

Here, it is assumed that the wireless terminals 20 encounter a disaster such as a major earthquake. At this time, in S304, the first base station 10 being the serving cell 10a transmits ETWS (Earthquake and Tsunami Warning System) information to the wireless terminals 20.

The ETWS information is a type of existing annunciation information specified in the 3GPP. The ETWS information is annunciation information used, as a trigger, by each of the wireless terminals 20 for a function of emitting a warning sound at a time of a disaster such as an earthquake or a tsunami and is transmitted, prior to these, to the wireless terminals 20, based on a precursor of the earthquake or the tsunami. Regarding, for example, the earthquake, by using predictability of the occurrence of the earthquake based on the measurement of a P wave being a preliminary tremor of the earthquake, it is possible to transmit the ETWS information to the wireless terminals 20 prior to generation of a vibration due to the earthquake. Note that the prediction of the earthquake is performed by a higher-level device and the base stations 10 transmit, based on prediction information received from the higher-level device, RTW information to the wireless terminals 20.

After that, as illustrated in S305 in FIG. 4, it is assumed that every one of the first base station 10a being the serving cell 10a and the second base station 10b being the other cell 10b stops an operation. From this, the base stations 10 become not able to transmit wireless signals (downlink signals).

At this time, in S306 in FIG. 4, the wireless terminals 20 each detect signal stop of the serving cell 10a. Based on, for example, a synchronization signal being a downlink signal periodically transmitted by the corresponding one of the base stations 10, it is possible for each of the wireless terminals 20 to detect the signal stop of the serving cell 10a. In the LTE system, as synchronization signals, two types of PSS (Primary Synchronization Signal) and SSS (Secondary Synchronization Signal) are specified, and the wireless terminals 20 are able to use these.

In the present embodiment, as described above, it is assumed that upon the reception of the ETWS information in S304 and the detection of the signal stop of the serving cell 10a in S306 in FIG. 4, the terminal-to-terminal communication initiation determination trigger is detected. From this, in S307, the wireless terminals 20 each perform determination of the terminal-to-terminal communication. In the present embodiment, as described above, M2 (described above) is adopted, as the wireless-terminal-20-wireless-terminal-20 initiation condition, for a trial of coupling to the other cells 10b, and a trial of coupling to the serving cell 10a is unconditionally skipped. Therefore, in S307, the wireless terminals 20 each omit a trial of coupling to the serving cell 10a and each perform a trial of coupling to the other cells 10b up to M2 times. Since S307 to S309 in FIG. 4 are the same as S206 to S208, respectively, in FIG. 3, the detailed descriptions thereof will be omitted.

Here, the reason why a combination of detection of the ETWS information and detection of the signal stop of the serving cell 10a is adopted as the terminal-to-terminal communication initiation determination trigger in the present embodiment will be described. While being specified annunciation information to be transmitted at a time of the occurrence of an earthquake, the ETWS information has insufficient accuracy and an insufficient information amount in an aspect, and it may be thought that it is not desirable to only define these as the terminal-to-terminal communication initiation determination trigger. On the other hand, the signal stop of the serving cell 10a may be detected except when the serving cell 10a stops an operation (when it is very difficult for a signal to reach, for example, in the inside of a tunnel or the like), it may be thought that it is not desirable to only define these as the terminal-to-terminal communication initiation determination trigger. Therefore, in the present embodiment, a combination of these is adopted as the terminal-to-terminal communication initiation determination trigger.

According to the second embodiment described above, while initially performing wireless communication via the serving cell 10a (coupling base station 10a), the wireless terminals 20 each make a transition to the terminal-to-terminal communication once in association with simultaneous operation stop of the base stations 10 and each return to the wireless communication via the corresponding one of the base stations 10 in association with recovery or the like of the base stations 10. In addition, the wireless terminals 20 each give up coupling to the base stations 10 earlier than usual and are each able to swiftly initiate the terminal-to-terminal communication at an adequate timing. From this, compared with the technology of the related art, it is possible to considerably suppress an interruption of wireless communication, and it becomes possible to suppress useless power consumption in the wireless terminals 20. Therefore, according to the second embodiment, it becomes possible to solve the problem contained by the reference technology described above.

### Third Embodiment

A third embodiment specifically realizes the first embodiment in the same way as the second embodiment and, in particular, adopts a start-stop signal as the terminal-to-terminal communication initiation determination trigger.

Since the third embodiment has many parts in common with the second embodiment, the third embodiment will be described in detail with a focus on points different from the second embodiment, in what follows. Note that, in the third embodiment, descriptions that overlap with the second embodiment will be arbitrarily omitted.

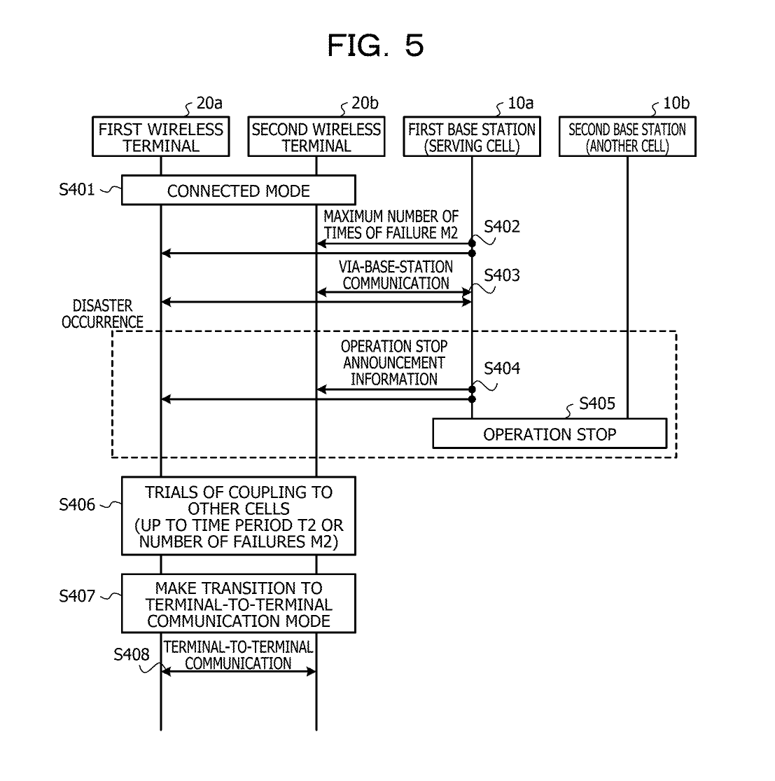

FIG. 5 is a diagram illustrating an example of a processing sequence according to the third embodiment. Since the assumption of the third embodiment illustrated in FIG. 5 is the same as that of the reference technology or each of the embodiments, described above, the description thereof will be omitted.

Since S401 to S403 in FIG. 5 are the same as S301 to S303, respectively, in FIG. 4, the detailed descriptions thereof will be omitted. Note that, in the present embodiment, it is assumed that, in the same way as in the exemplification in the first embodiment, M2 (described above) is adopted, as the wireless-terminal-20-wireless-terminal-20 initiation condition, for a trail of coupling to the other cells 10b and a trial of coupling to the serving cell 10a is unconditionally skipped. In this regard, however, note that these are just examples and the terminal-to-terminal communication is not limited to these.

Next, a disaster occurs, and in S404 in FIG. 5, the base stations 10 each transmit operation stop information to the wireless terminals 20. Here, an operation stop signal is a signal for pointing out (or announcing), to the wireless terminals 20, that the corresponding one of the base stations 10 stops an operation.

As the operation stop signal, two types of variation are conceivable. As a first variation of the operation stop signal, it is conceivable that each of the base stations 10 only points out, to the wireless terminals 20, operation stop of the base station 10 itself. As an example, it is conceivable that the base stations 10 each recognize, based on the ETWS information, the intensity of an earthquake center and a distance from the earthquake center, each estimate, based on these, a possibility that the base station 10 itself stops, and each transmit the operation stop signal to the wireless terminals 20 in a case of the high possibility. In addition, it is conceivable that the base stations 10 each actually perform sensing of a vibration of the earthquake or the like and when normal operation is impossible, the base stations 10 each transmit the operation stop signal to the wireless terminals 20.

As the second variation of the operation stop signal, it is conceivable that each of the base stations 10 points out, to the wireless terminals 20, simultaneous operation stop including not only the base station 10 itself and but also the other neighboring base stations 10b. As an example, it is conceivable that the base stations 10 each recognize, based on the ETWS information, the intensity of an earthquake center and a location of the earthquake center, each estimate, based on these and preliminarily acquired locations or the like of the other base stations 10, a possibility that the base station 10 itself and the other base stations 10 simultaneously stop, and each transmit the operation stop signal to the wireless terminals 20 in a case of the high possibility. In addition, it is conceivable that in a case of receiving, from a given number of the other base stations 10, signals each informing of operation stop, the base stations 10 each transmit the operation stop signal to the wireless terminals 20.

Here, since only indicating operation stop of one of the base stations 10 itself, the first variation of the operation stop signal does not exactly lead to simultaneous operation stop of the base stations 10. Therefore, it is inadequate that this is independently defined as the terminal-to-terminal communication initiation determination trigger, and it is desirable to define a combination of, for example, this and the ETWS information, as the terminal-to-terminal communication initiation determination trigger. In contrast, it is possible to independently define the second variation of the operation stop signal as the terminal-to-terminal communication initiation determination trigger. Note that FIG. 5 is a processing sequence in a case of adopting the operation stop signal of the second variation. In a case of adopting the operation stop signal of the first variation, it is desirable to perform transmission and reception of the ETWS signal.

While after that, in S405 in FIG. 5, the base stations 10 each stop an operation, in S404 it is possible for each of the wireless terminals 20 to detect the terminal-to-terminal communication initiation determination trigger. From this, in S406, the wireless terminals 20 each perform determination of initiation of the terminal-to-terminal communication, more specifically, a trial of coupling to the other cells 10b, for example. Since S406 to S408 in FIG. 5 are the same as S307 to S309, respectively, in FIG. 4, the detailed descriptions thereof will be omitted.

Note that while FIG. 5 corresponds to a case of adopting the start-stop signal as the terminal-to-terminal communication initiation determination trigger, these may be further combined with detection of the radio problem. Here, the radio problem detection is processing corresponding to 104 in FIG. 2. Since, in the specification of the 3GPP of the related art, the radio problem detection is defined as a trigger for a trial of cell coupling, it is conceivable that the radio problem detection is combined, thereby further enhancing a consistency between the specification and the present embodiment.

According to the third embodiment described above, while initially performing wireless communication via the serving cell 10a (coupling base station 10a), the wireless terminals 20 each make a transition to the terminal-to-terminal communication once in association with simultaneous operation stop of the base stations 10 and each return to the wireless communication via the corresponding one of the base stations 10 in association with recovery or the like of the base stations 10. In addition, the wireless terminals 20 each give up coupling to the base stations 10 earlier than usual and are each able to swiftly initiate the terminal-to-terminal communication at an adequate timing. From this, compared with the technology of the related art, it is possible to considerably suppress an interruption of wireless communication, and it becomes possible to suppress useless power consumption in the wireless terminals 20. Therefore, according to the third embodiment, it becomes possible to solve the problem contained by the reference technology described above.

### Fourth Embodiment

A fourth embodiment specifically realizes the first embodiment in the same way as the second or third embodiment and, in particular, adopts detection of a vibration, performed by each of the wireless terminals 20 itself, as the terminal-to-terminal communication initiation determination trigger.

Since the fourth embodiment has many parts in common with the second embodiment, the fourth embodiment will be described in detail with a focus on points different from the second embodiment, in what follows. Note that, in the fourth embodiment, descriptions that overlap with the second embodiment will be arbitrarily omitted.

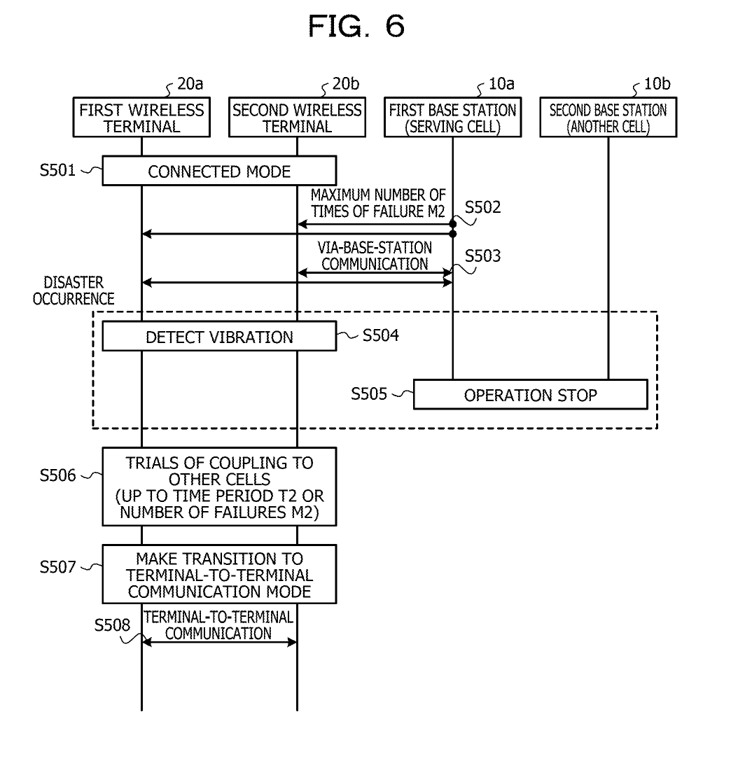

FIG. 6 is a diagram illustrating an example of a processing sequence according to the fourth embodiment. Since the assumption of the fourth embodiment illustrated in FIG. 6 is the same as that of the reference technology or each of the embodiments, described above, the description thereof will be omitted.

Since S501 to S503 in FIG. 6 are the same as S301 to S303, respectively, in FIG. 4, the detailed descriptions thereof will be omitted. Note that, in the present embodiment, it is assumed that, in the same way as in the exemplification in the first embodiment, M2 (described above) is adopted, as the wireless-terminal-20-wireless-terminal-20 initiation condition, for a trail of coupling to the other cells 10b and a trial of coupling to the serving cell 10a is unconditionally skipped. In this regard, however, note that these are just examples and the terminal-to-terminal communication is not limited to these.

Next, if a disaster occurs, in S504 in FIG. 6 the wireless terminals 20 themselves each detect a vibration (shake) of the earthquake. Here, the detection of the vibration, performed by each of the wireless terminals 20, may be realized by, for example, an acceleration sensor included in the wireless terminals 20. It goes without saying that, in the detection of an earthquake, performed by the acceleration sensor, all of existing technologies including technologies for enhancing detection accuracy are usable.

In the present embodiment, the detection of a vibration, performed by each of the wireless terminals 20 itself, is defined as the terminal-to-terminal communication initiation determination trigger. Therefore, in S505 in FIG. 6, the base stations 10 each stop an operation, in S504 it is possible for each of the wireless terminals 20 to detect the terminal-to-terminal communication initiation determination trigger. From this, in S506, the wireless terminals 20 each perform determination of initiation of the terminal-to-terminal communication, more specifically, a trial of coupling to the other cells 10b, for example. Since S506 to S508 in FIG. 6 are the same as S307 to S309, respectively, in FIG. 4, the detailed descriptions thereof will be omitted.

Note that while FIG. 6 corresponds to a case of adopting the detection of a vibration, performed by each of the wireless terminals 20, as the terminal-to-terminal communication initiation determination trigger, these may be further combined with the detection of the radio problem. Here, the radio problem detection is processing corresponding to 104 in FIG. 2. Since, in the specification of the 3GPP of the related art, the radio problem detection is defined as a trigger for a trial of cell coupling, it is conceivable that the radio problem detection is combined, thereby further enhancing a consistency between the specification and the present embodiment.

In addition, since the detection of a vibration of an earthquake, performed by using an acceleration sensor or the like, does not automatically have sufficient detection accuracy, it may be thought that it is more desirable to combine it with another event. In accordance with this thought, as the terminal-to-terminal communication initiation determination trigger, a combination of the detection of a vibration, performed by each of the wireless terminals 20, and another event may be defined. In that case, in addition to the detection of the radio problem, the above-mentioned detection of signal stop (corresponding to S306 in FIG. 4), the above-mentioned reception of the ETWS information (corresponding to S304 in FIG. 4), or the like may be adopted as the other event, for example.

According to the fourth embodiment described above, while initially performing wireless communication via the serving cell 10a (coupling base station 10a), the wireless terminals 20 each make a transition to the terminal-to-terminal communication once in association with simultaneous operation stop of the base stations 10 and each return to the wireless communication via the corresponding one of the base stations 10 in association with recovery or the like of the base stations 10. In addition, the wireless terminals 20 each give up coupling to the base stations 10 earlier than usual and are each able to swiftly initiate the terminal-to-terminal communication at an adequate timing. From this, compared with the technology of the related art, it is possible to considerably suppress an interruption of wireless communication, and it becomes possible to suppress useless power consumption in the wireless terminals 20. Therefore, according to the fourth embodiment, it becomes possible to solve the problem contained by the reference technology described above.

[Examples of Modifications to Individual Embodiments]

Here, examples of modifications to the above-mentioned individual embodiments will be described. These may be arbitrarily combined with the above-mentioned individual embodiments.

As a first example of a modification, an example of a modification related to a measurement report (measurement report) will be described. In each of the above-mentioned embodiments, the wireless terminals 20 each maintain the connected mode until the terminal-to-terminal communication is initiated after the occurrence of an earthquake. Therefore, in this period, according to the specification of the 3GPP, measurements (measurements) of respective wireless signals transmitted by the serving cell 10a and neighboring cells are performed, and measurement reports are transmitted to the serving cell 10a.

Here, while a transmission timing of the measurement report is parameterized, generally the measurement report is relatively frequently repeated in many cases. The reason is that if the frequency of the measurement report is low, there is a possibility that handover become not able to be performed at an adequate timing. However, no handover is performed until the terminal-to-terminal communication is initiated after the occurrence of an earthquake. Therefore, it may be thought that repeatedly performing a measurement and a measurement report many times is highly wasteful in view of power consumption, wireless resources, or the like.

Therefore, it is conceivable that after the occurrence of an earthquake, in other words, after the wireless terminals 20 each detect the terminal-to-terminal communication initiation determination trigger, the wireless terminals 20 each autonomously restrict transmission of the measurement report. It is conceivable that an upper limit is set on the number of measurement reports, the frequency thereof is reduced, or no measurement report is issued. It may be thought that by doing so, it is possible to solve the above-mentioned problem.

Note that it is conceivable that, based on the same thought as this, a restriction is put on a measurement gap being a time period for performing a measurement for another system. Here, details are omitted.

As a second example of a modification, an example of a modification related to initiation of the terminal-to-terminal communication will be described. In each of the above-mentioned embodiments, if, in the terminal-to-terminal communication initiation determination, it is determined that the terminal-to-terminal communication is desired, the wireless terminals 20 each make a transition from the connected mode to the terminal-to-terminal communication mode, and the terminal-to-terminal communication is autonomously initiated (S206 to S208 in FIG. 3 or the like, for example). However, it may be thought that, in light of the fact that a possibility of false detection of the terminal-to-terminal communication initiation determination trigger or false determination of the terminal-to-terminal communication initiation determination is left, there is room for examination in autonomously initiating the terminal-to-terminal communication in such a way.

Therefore, it is conceivable that when, in the terminal-to-terminal communication initiation determination, it is determined that the terminal-to-terminal communication is desired, users are prompted to initiate the terminal-to-terminal communication. It is conceivable that initiation of the terminal-to-terminal communication is suggested to users by using, for example, warning sounds, screen displays, or the like and the users are requested to confirm permission to initiate the terminal-to-terminal communication. In addition, only when users permit the terminal-to-terminal communication, the wireless terminals 20 each make a transition from the connected mode to the terminal-to-terminal communication mode and each initiate the terminal-to-terminal communication. It may be thought that by doing so, it is possible to solve the above-mentioned problem.

[Network Configuration of Wireless Communication System of Each of Embodiments]

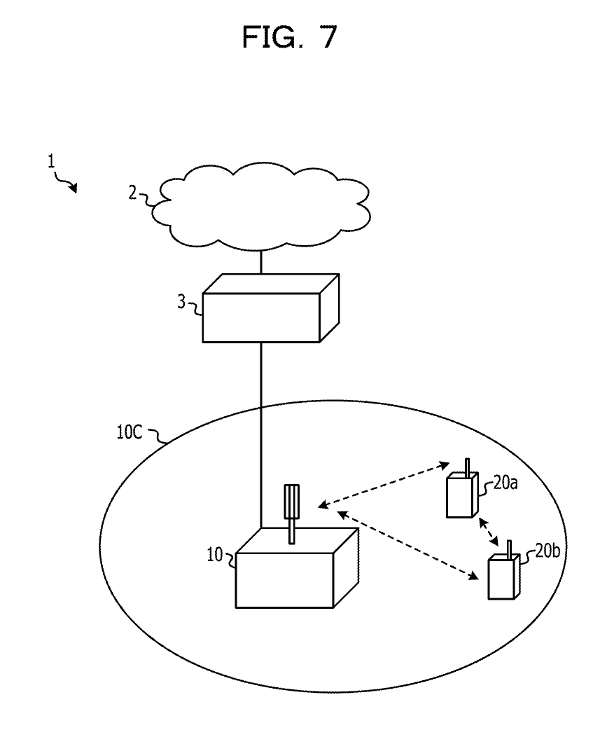

Next, based on FIG. 7, a network configuration of a wireless communication system 1 of each of embodiments will be described. As illustrated in FIG. 7, the wireless communication system 1 includes one of the base stations 10 and the wireless terminals 20. Note that while in FIG. 7, the wireless terminal 20a and the wireless terminal 20b being the two wireless terminals 20 are exemplified, it goes without saying that this is just an example. The corresponding one of the base stations forms a cell C10. The wireless terminals 20 exist in the cell C10.

The corresponding one of the base stations 10 is coupled to a network device 3 via a wired connection, and the network device 3 is coupled to a network 2 via a wired connection. The corresponding one of the base stations 10 is provided so as to be able to transmit and receive data and control information to and from another one of the base stations 10 via the network device 3 and the network 2.

By separating a function of wireless communication with the wireless terminals 20 and digital signal processing and a control function, the corresponding one of the base stations 10 may be provided as different devices. In this case, a device equipped with the wireless communication function is called an RRH (Remote Radio Head), and a device equipped with the digital signal processing and the control function is called a BBU (Base Band Unit). The RRH is installed so as to be pulled out of the BBU, and an optical fiber or the like may establish a wired connection therebetween. In addition, the corresponding one of the base stations 10 may be one of the base stations 10 that have various sizes and that include small base stations 10 (including a micro base station 10, a femto base station 10, and so forth) such as a macro base station 10, a pico base station 10, and so forth. In addition, when a relay station to relay wireless communication between the corresponding one of the base stations 10 and the wireless terminals 20 is used, the relay station (transmission and reception to and from the wireless terminals 20 and control thereof) may be included in the base stations 10 of the present application.

On the other hand, as illustrated in FIG. 7, the wireless terminals 20 each perform communication with the corresponding one of the base stations 10 by using wireless communication. In addition, in FIG. 7, as an example, the wireless terminal 20a and the wireless terminal 20b perform wireless terminal-to-terminal communication. In this way, one of the wireless terminals 20 performs wireless terminal-to-terminal communication with the other of the wireless terminals 20.

Each of the wireless terminals 20 may be one of the wireless terminals 20 such as a mobile phone, a smartphone, a PDA (Personal Digital Assistant), a personal computer (Personal Computer), and various kinds of device or apparatus (a sensor device and so forth) each having a wireless communication function. In addition, when a relay station to relay wireless communication between the corresponding one of the base stations 10 and the wireless terminals 20 is used, the relay station (transmission and reception to and from the corresponding one of the base stations 10 and control thereof) may be included in the wireless terminals 20 of the present application.

The network device 3 includes, for example, a communication unit and a control unit, and these individual configuration parts are coupled so as to be able to unidirectionally or bidirectionally input and output signals and pieces of data. The network device 3 is realized by, for example, a gateway. Regarding a hardware configuration of the network device 3, the communication unit is realized by an interface circuit, and the control unit is realized by a processor and a memory, for example.

Note that specific conditions of the distribution or integration of individual configuration elements of the base stations 10 and the wireless terminals 20 are not limited to conditions of the individual embodiments, and all or some of the individual devices may be functionally or physically integrated or distributed in arbitrary units, depending on various kinds of loads and various usage situations. Memories may be coupled via networks or cables, as external devices of the base stations 10 and the wireless terminals 20, for example.

[Functional Configurations of Respective Devices in Wireless Communication System of Each of Embodiments]

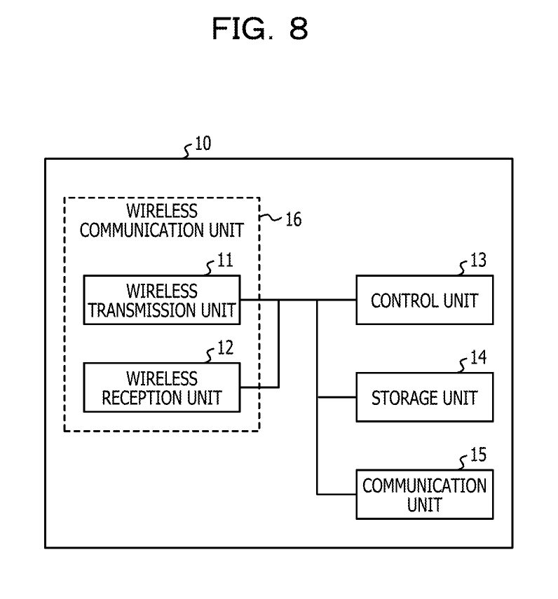

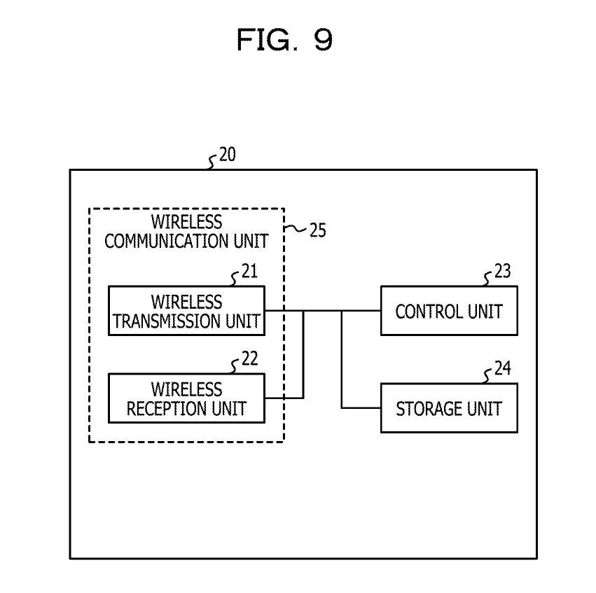

Next, based on FIG. 8 and FIG. 9, functional configurations of respective devices in a wireless communication system of each of the embodiments will be described. Note that, as described above, in a case of referring to the wireless terminals 20, the first wireless terminal 20a and the second wireless terminal 20b in each of the above-mentioned embodiments are included.

FIG. 8 is a functional block diagram illustrating an example of configurations of the base stations 10. As illustrated in FIG. 8, the base stations 10 each include, for example, a wireless transmission unit 11, a wireless reception unit 12, a control unit 13, a storage unit 14, and a communication unit 15. These individual configuration parts are coupled so as to be able to unidirectionally or bidirectionally input and output signals and pieces of data. Note that the wireless transmission unit 11 and the wireless reception unit 12 are collectively referred to as a wireless communication unit 16.

The wireless transmission unit 11 transmits data signals and control signals via an antenna by using wireless communication. Note that the antenna may be shared by transmission and reception. The wireless transmission unit 11 transmits wireless signals (downlink wireless signals) to the wireless terminals 20. The wireless signals transmitted by the wireless transmission unit 11 may include arbitrary user data and control information (subjected to coding, modulation, and so forth), a reference signal, and so forth, which are directed at the wireless terminals 20.

As specific examples of the wireless signals transmitted by the wireless transmission unit 11, individual wireless signals (arrows in drawings) transmitted to the wireless terminals 20 by the corresponding one of the base stations 10 in FIG. 3 to FIG. 6 may be cited. The wireless signals transmitted by the wireless transmission unit 11 are not limited to these and include all wireless signals transmitted to the wireless terminals 20 by the base stations 10 in the above-mentioned individual embodiments or examples of a modification.

The wireless reception unit 12 receives data signals and control signals via an antenna by using wireless communication. The wireless reception unit 12 receives wireless signals (uplink wireless signals) from the wireless terminals 20. The wireless signals received by the wireless reception unit 12 may include arbitrary user data and control information (subjected to coding, modulation, and so forth), a reference signal, and so forth, which are transmitted by the wireless terminals 20.

As specific examples of the wireless signals received by the wireless reception unit 12, wireless signals (arrows in drawings) received from the wireless terminals 20 by the corresponding one of the base stations 10 in FIG. 3 to FIG. 6 may be cited. The signals received by the wireless reception unit 12 are not limited to these and include all wireless signals received from the wireless terminals 20 by the corresponding one of the base stations 10 in the above-mentioned individual embodiments or examples of a modification.

The control unit 13 outputs, to the wireless transmission unit 11, data and control information, which are to be transmitted to the wireless terminals 20. The control unit 13 inputs, from the wireless reception unit 12, data and control information, received from the wireless terminals 20. The control unit 13 inputs and outputs data, control information, a program, and so forth from and to the storage unit 14 described later. The control unit 13 inputs and outputs data, from and to the communication unit 15 described later, data and control information transmitted and received with the other base stations 10 or the like as partners. In addition to these, the control unit 13 performs various control in the corresponding one of the base stations 10.

As specific examples of processing operations controlled by the control unit 13, control of individual signals (arrows in drawings) transmitted and received by the corresponding one of the base stations 10 in FIG. 3 to FIG. 6 and control of individual processing operations (rectangles in the drawings) performed by the corresponding one of the base stations 10 may be cited. The processing operations controlled by the control unit 13 are not limited to these and include control related to all processing operations performed by the corresponding one of the base stations 10 in the above-mentioned individual embodiments or examples of a modification.

The storage unit 14 stores therein various kinds of information such as data, control information, a program, and so forth. The various kinds of information stored by the storage unit 14 include all pieces of information that may be stored in the corresponding one of the base stations 10 in the above-mentioned individual embodiments or examples of a modification.

By using wired signals and so forth (may be wireless signals), the communication unit 15 transmits and receives data and control information with the other base stations 10 or the like as partners. As specific examples of the wired signals and so forth transmitted and received by the communication unit 15, individual wired signals and so forth transmitted and received by the corresponding one of the base stations 10 with the other base stations 10 as partners in the individual embodiments may be cited. The wired signals and so forth transmitted and received by the communication unit 15 are not limited to these and include all wired signals and so forth transmitted and received by the corresponding one of the base stations 10 with the other base stations 10 or the like as partners in the above-mentioned individual embodiments or examples of a modification.

Note that the corresponding one of the base stations 10 may transmit and receive wireless signals to and from wireless communication devices (for example, the other base stations 10 or relay stations) other than the wireless terminals 20 via the wireless transmission unit 11 and the wireless reception unit 12.

FIG. 9 is a functional block diagram illustrating an example of configurations of the wireless terminals 20. As illustrated in FIG. 9, the wireless terminals 20 each include, for example, a wireless transmission unit 21, a wireless reception unit 22, a control unit 23, and a storage unit 24. These individual configuration parts are coupled so as to be able to unidirectionally or bidirectionally input and output signals and pieces of data. Note that the wireless transmission unit 21 and the wireless reception unit 22 are collectively referred to as a wireless communication unit 25.

The wireless transmission unit 21 transmits data signals and control signals via an antenna by using wireless communication. Note that the antenna may be shared by transmission and reception. The wireless transmission unit 21 transmits wireless signals (uplink wireless signals) to the base stations 10. The wireless signals transmitted by the wireless transmission unit 21 may include arbitrary user data and control information (subjected to coding, modulation, and so forth), a reference signal, and so forth, which are directed at the base stations 10.

In addition, the wireless transmission unit 21 is able to transmit wireless signals to the other wireless terminal 20 (the wireless terminal-to-terminal communication). The wireless signals transmitted by the wireless transmission unit 21 may include arbitrary user data and control information (subjected to coding, modulation, and so forth), a reference signal, and so forth, which are directed at the other wireless terminal 20.

As specific examples of the wireless signals transmitted by the wireless transmission unit 21, individual wireless signals (arrows in drawings) transmitted to the base stations 10 by the corresponding one of the wireless terminals 20 in FIG. 3 to FIG. 6 and individual wireless signals transmitted to the other wireless terminal 20 by the corresponding one of the wireless terminals 20 may be cited. The wireless signals transmitted by the wireless transmission unit 21 are not limited to these and include all wireless signals transmitted to the base stations 10 by the corresponding one of the wireless terminals 20 and all wireless signals transmitted to the other wireless terminal 20 by the corresponding one of the wireless terminals 20 in the above-mentioned individual embodiments or examples of a modification.

The wireless reception unit 22 receives data signals and control signals via an antenna by using wireless communication. The wireless reception unit 22 receives wireless signals (downlink wireless signals) from the base stations 10. The wireless signals received by the wireless reception unit 22 may include arbitrary user data and control information (subjected to coding, modulation, and so forth), a reference signal, and so forth, which are transmitted by the base stations 10.

In addition, the wireless reception unit 22 is able to receive wireless signals from the other wireless terminal 20 (the wireless terminal-to-terminal communication). The wireless signals transmitted by the wireless reception unit 22 may include arbitrary user data and control information (subjected to coding, modulation, and so forth), a reference signal, and so forth from the other wireless terminal 20.

As specific examples of the wireless signals received by the wireless reception unit 22, individual wireless signals (arrows in drawings) received from the base stations 10 by the corresponding one of the wireless terminals 20 in FIG. 3 to FIG. 6 and individual wireless signals received from the other wireless terminal 20 by the corresponding one of the wireless terminals 20 may be cited. The signals received by the wireless reception unit 22 are not limited to these and include all wireless signals received from the base stations 10 by the corresponding one of the wireless terminals 20 and all wireless signals received from the other wireless terminal 20 by the corresponding one of the wireless terminals 20 in the above-mentioned individual embodiments or examples of a modification.

The control unit 23 outputs, to the wireless transmission unit 21, data and control information, which are to be transmitted to the base stations 10. The control unit 23 inputs, from the wireless reception unit 22, data and control information, received from the base stations 10. The control unit 23 inputs and outputs data, control information, a program, and so forth from and to the storage unit 24 described later. In addition to these, the control unit 23 performs various control in the corresponding one of the wireless terminals 20.

As specific examples of processing operations controlled by the control unit 23, control of individual signals (arrows in drawings) transmitted and received by the corresponding one of the wireless terminals 20 in FIG. 3 to FIG. 6 and control of individual processing operations (rectangles in the drawings) performed by the corresponding one of the wireless terminals 20 may be cited. The processing operations controlled by the control unit 23 are not limited to these and include control related to all processing operations performed by the corresponding one of the wireless terminals 20 in the above-mentioned individual embodiments or examples of a modification.

The storage unit 24 stores therein various kinds of information such as data, control information, a program, and so forth. The various kinds of information stored by the storage unit 24 include all pieces of information that may be stored in the corresponding one of the wireless terminals 20 in the above-mentioned individual embodiments or examples of a modification.

Note that the corresponding one of the wireless terminals 20 may transmit and receive wireless signals to and from wireless communication devices (for example, the other base stations 10 or relay stations) other than the base stations 10 via the wireless transmission unit 21 and the wireless reception unit 22.

[Hardware Configurations of Respective Devices in Wireless Communication System in Each of Embodiments]

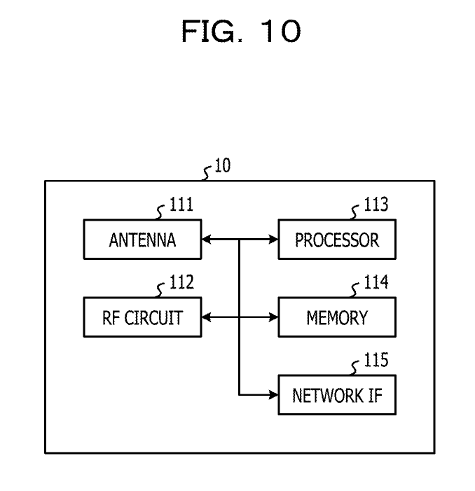

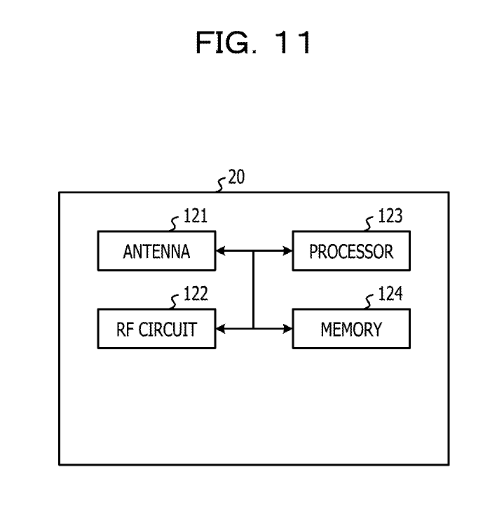

Based on FIG. 10 and FIG. 11, hardware configurations of respective devices in a wireless communication system of each of the embodiments and examples of a modification will be described. Note that, as described above, in a case of referring to the wireless terminals 20, the first wireless terminal 20a and the second wireless terminal 20b in each of the above-mentioned embodiments are included.

FIG. 10 is a diagram illustrating an example of hardware configurations of the base stations 10. As illustrated in FIG. 10, the base stations 10 each include, as configuration elements of hardware, for example, an RF (Radio Frequency) circuit 112 equipped with an antenna 111, a processor 113, a memory 114, and a network IF (Interface) 115. These individual configuration elements are coupled so as to be able to input and output various kinds of signals and data via a bus.

The processor 113 is, for example, a CPU (Central Processing Unit) or a DSP (Digital Signal Processor). In the present application, the processor 113 may be realized by a digital electronic circuit. As the digital electronic circuit, for example, an ASIC (Application Specific Integrated Circuit), an FPGA (Field-Programming Gate Array), an LSI (Large Scale Integration), or the like may be cited, for example.

The memory 114 includes at least one of, for example, a RAM (Random Access Memory) such as an SDRAM (Synchronous Dynamic Random Access Memory), a ROM (Read Only Memory), and a flash memory and stores therein a program, control information, and data. In addition to these, the base stations may each include an auxiliary storage device (a hard disk or the like) or the like, not illustrated.

A correspondence between the functional configuration of each of the base stations 10, illustrated in FIG. 8, and the hardware configuration of each of the base stations 10, illustrated in FIG. 10, will be described. The wireless transmission unit 11 and the wireless reception unit 12 (or the wireless communication unit 16) are realized by, for example, the RF circuit 112, or the antenna 111 and the RF circuit 112. The control unit 13 is realized by, for example, the processor 113, the memory 114, a digital electronic circuit not illustrated, and so forth. The storage unit 14 is realized by, for example, the memory 114. The communication unit 15 is realized by, for example, the network IF 115.

FIG. 11 is a diagram illustrating an example of hardware configurations of the wireless terminals 20. As illustrated in FIG. 11, the wireless terminals 20 each include, as configuration elements of hardware, for example, an RF (Radio Frequency) circuit 122 equipped with an antenna 121, a processor 123, and a memory 124. These individual configuration elements are coupled so as to be able to input and output various kinds of signals and data via a bus.

The processor 123 is, for example, a CPU (Central Processing Unit) or a DSP (Digital Signal Processor). In the present application, the processor 123 may be realized by a digital electronic circuit. As the digital electronic circuit, for example, an ASIC (Application Specific Integrated Circuit), an FPGA (Field-Programming Gate Array), an LSI (Large Scale Integration), or the like may be cited, for example.

The memory 124 includes at least one of, for example, a RAM (Random Access Memory) such as an SDRAM (Synchronous Dynamic Random Access Memory), a ROM (Read Only Memory), and a flash memory and stores therein a program, control information, and data.

A correspondence between the functional configuration of each of the wireless terminals 20, illustrated in FIG. 9, and the hardware configuration of each of the wireless terminals 20, illustrated in FIG. 11, will be described. The wireless transmission unit 21 and the wireless reception unit 22 (or the wireless communication unit 25) are realized by, for example, the RF circuit 122, or the antenna 121 and the RF circuit 122. The control unit 23 is realized by, for example, the processor 123, the memory 124, a digital electronic circuit not illustrated, and so forth. The storage unit 24 is realized by, for example, the memory 124.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless terminal comprising:
a memory; and
a processor coupled to the memory and the processor configured to:
cause the wireless terminal to make a transition to an idle mode when, after it is determined that a first wireless link established with a wireless station by the wireless terminal is not maintained, a cumulative processing time from initiation of processing for selecting one of wireless stations other than the wireless station and for establishing a second wireless link or the number of times of failure in the processing reaches a first threshold value, wherein
in accordance with a quality of the first wireless link or the second wireless link, the processor is configured to initiate terminal-to-terminal communication or prompt to initiate the terminal-to-terminal communication without causing the wireless terminal to make a transition to the idle mode.

2. The wireless terminal according to claim 1, wherein
when the cumulative processing time or the number of times of failure reaches a second threshold value less than the first threshold value, the processor is configured to terminate the processing for establishing the second wireless link and initiates the terminal-to-terminal communication or prompt to initiate the terminal-to-terminal communication.

3. The wireless terminal according to claim 2, wherein
the processor is configured to receive the second threshold value from the wireless station.

4. The wireless terminal according to claim 1, wherein
when the first wireless link is not maintained, the processor is configured to initiate the processing for establishing the second wireless link or prompt to initiate the terminal-to-terminal communication without performing a recovery of the first wireless link.

5. The wireless terminal according to claim 1, wherein
the processor is configured to receive, from the wireless station, a signal indicating a possibility of a disaster, and when it is detected that a predetermined signal is not received from the wireless station, the processor is configured to determine that the first wireless link in not maintained.

6. The wireless terminal according to claim 1, wherein
when a signal indicating operation stop of the wireless station is received from the wireless station, the processor is configured to determine that the first wireless link is not maintained.

7. The wireless terminal according to claim 1, wherein
when a predetermined vibration is detected, the processor is configured to determine that the first wireless link is not maintained.

8. The wireless terminal according to claim 1, further comprising:
an output device configured to output information, wherein
the processor is configured to prompt to initiate the terminal-to-terminal communication by causing the output unit to output information suggesting initiation of the terminal-to-terminal communication.

9. A wireless station comprising:
a memory; and
a processor coupled to the memory and the processor configured transmit a wireless signal to a wireless terminal, wherein
the wireless terminal is configured to cause the wireless terminal to make a transition to an idle mode when, after it is determined that a first wireless link established with a wireless station by the wireless terminal is not maintained, a cumulative processing time from initiation of processing for selecting one of wireless stations other than the wireless station and for establishing a second wireless link or the number of times of failure in the processing reaches a first threshold value,
in accordance with a quality of the first wireless link or the second wireless link, the wireless terminal is configured to initiate terminal-to-terminal communication or prompt to initiate the terminal-to-terminal communication without causing the wireless terminal to make a transition to the idle mode, and
the processor is configured to transmit the second threshold value to the wireless terminal.

10. A wireless communication system comprising:
a wireless terminal;
a wireless station; and
one or more other wireless stations other than the wireless station, wherein
the wireless terminal is configured to cause the wireless terminal to make a transition to an idle mode when, after it is determined that a first wireless link established with a wireless station by the wireless terminal is not maintained, a cumulative processing time from initiation of processing for selecting one of the one or more other wireless stations and for establishing a second wireless link or the number of times of failure in the processing reaches a first threshold value,
in accordance with a quality of the first wireless link or the second wireless link, the wireless terminal is configured to initiate terminal-to-terminal communication or prompt to initiate the terminal-to-terminal communication without causing the wireless terminal to make a transition to the idle mode.

11. A wireless communication method, wherein
causing the wireless terminal to make a transition to an idle mode when, after it is determined that a first wireless link established with a wireless station by the wireless terminal is not maintained, a cumulative processing time from initiation of processing for selecting one of wireless stations other than the wireless station and for establishing a second wireless link or the number of times of failure in the processing reaches a first threshold value, wherein
in accordance with a quality of the first wireless link or the second wireless link, terminal-to-terminal communication is initiated or prompted to initiate without causing the wireless terminal to make a transition to the idle mode.
